(19) United States
(12) Patent Application Publication
(10) Pub. No.: US 2021/0048982 A1
(43) Pub. Date: Feb. 18, 2021

(54) PARTIAL PRODUCT FLOATING-POINT MULTIPLICATION CIRCUITRY OPERAND SUMMATION

(71) Applicant: International Business Machines Corporation, Armonk, NY (US)

(72) Inventors: Michael Klein, Schoenaich (DE); Nicol Hofmann, Leinfelden-Echterdingen (DE); Kerstin Claudia Schelm, Stuttgart (DE); Tina Babinsky, Steinenbronn (DE)

(21) Appl. No.: 16/538,985

(22) Filed: Aug. 13, 2019

(51) Int. Cl. G06F 7/487; G06F 7/485

(52) U.S. Cl. CPC G06F 7/4876; G06F 7/485

(57) ABSTRACT

A method includes masking a first fraction to generate a masked first fraction according to a comparison of a first exponent associated with the first fraction and a second exponent associated with a second fraction. The method also includes inserting the masked first fraction into mask adder circuitry of a partial product tree. The method also includes combining the masked first fraction with partial products of the partial product tree, the partial products having a value of zero. The method further includes combining the masked first fraction and the second fraction.

### BACKGROUND

The present invention relates to partial product floating-point multiplier addition, and more specifically, to the use of partial product trees for operand summation.

### SUMMARY

Embodiments of the present invention are directed to methods, systems, and circuitry for multiplier summation. A non-limiting example method includes masking a first fraction to generate a masked first fraction according to a comparison of a first exponent associated with the first fraction and a second exponent associated with a second fraction as a masked first fraction. The method includes inserting the masked first fraction into mask adder circuitry of a partial product tree. The method includes combining the masked first fraction with partial products of the partial product tree, the partial products having a value of zero. The method includes combining the masked first fraction and the second fraction.

Embodiments also include a floating-point unit that includes operand mask circuitry configured to mask a first fraction to generate a masked first fraction according to a difference between a first exponent associated with the first fraction and a second exponent associated with a second fraction. The floating-point unit includes multiplication circuitry including a partial product tree configured to output a multiplication result and having a first partial product stage cascaded with a second partial product stage. The second partial product stage includes multiplier adder circuitry having a multiplier adder input connected to the first partial product stage. The second partial product stage includes mask adder circuitry having a mask adder input connected to the operand mask circuitry.

Embodiments further include a floating-point unit that includes multiplication circuitry including a partial product tree configured to output a multiplication result and having a first partial product stage cascaded with a second partial product stage. The second partial product stage includes multiplier adder circuitry having a multiplier adder input connected to the first partial product stage. The second partial product stage includes mask adder circuitry having a mask adder input connected to the operand mask circuitry configure to receive a masked first fraction based on a difference between a first exponent associated with the first fraction and a second exponent associated with a second fraction.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a first floating-point number, a second floating-point number, and a masked floating-point number in accordance with one or more embodiments of the present invention;

FIG. 2 illustrates a block diagram of a portion of a floating-point unit in accordance with one or more embodiments of the present invention;

FIG. 3 illustrates multiplication circuitry in accordance with one or more embodiments of the present invention; and

FIG. 4 illustrates a method of using multiplication circuitry for operand summation in accordance with one or more embodiments of the present invention.

### DETAILED DESCRIPTION

Computers often use floating-point units to perform operations on floating-point numbers. Floating-point numbers may be defined in various formats, including binary floating-point or hexadecimal floating-point. The fraction portion of floating-point numbers may not be normalized prior to operation performance. Normalization shifting may be done one or more bits at a time. The number of bits shifted may be dependent on the type of floating-point number. As just one example, a hexadecimal floating-point number may be shifted by multiples of four bits. There may be multiple representations of the same numerical values. As a hexadecimal floating-point example (in which the two leftmost hexadecimal places encode the exponent):
0x01A00000=0x020A0000=0x0300A000
   Additionally, representations of zero may include any fractions defined as “x0 . . . 0” regardless of the exponent associated therewith. As one non-limiting example, addition of two hexadecimal floating-point numbers includes exponent comparison, fractional alignment, and signed fraction addition. The exponents of the two operands may be compared and the fraction accompanying the smaller characteristic is aligned with the other fraction by a shift. Shifting may occur one bit at a time until the incrementally reduced exponents are equal. As such, inaccurate mathematical results may occur, including zero plus an insignificant number is equal to zero instead of the insignificant number.

A floating-point unit may include a fused multiplication-addition pipeline. That is, floating-point units may compute Equation 1 below without regard to an additive or multiplicative operation request.

Result=(A×C)+B, (1)

where A is a first operand, C is a second operand, and B is zero in a multiplication operation mode and A is a first operand, C is one, and B is a second operand in an addition operation mode. Multiplexors (muxes) may provide the fused multiplication-addition pipeline the ability to select which operand to use, according to the operation request. The fused multiplication-addition pipeline may include a partial product tree for calculating the multiplicative result, which is unused during additive operation requests. The partial product tree may be used to reduce the circuitry footprint of the floating-point unit. That is, one of the operands associated with the additive operation may be inserted into the partial product tree, and the operand associated with the identity multiplier may be zero.

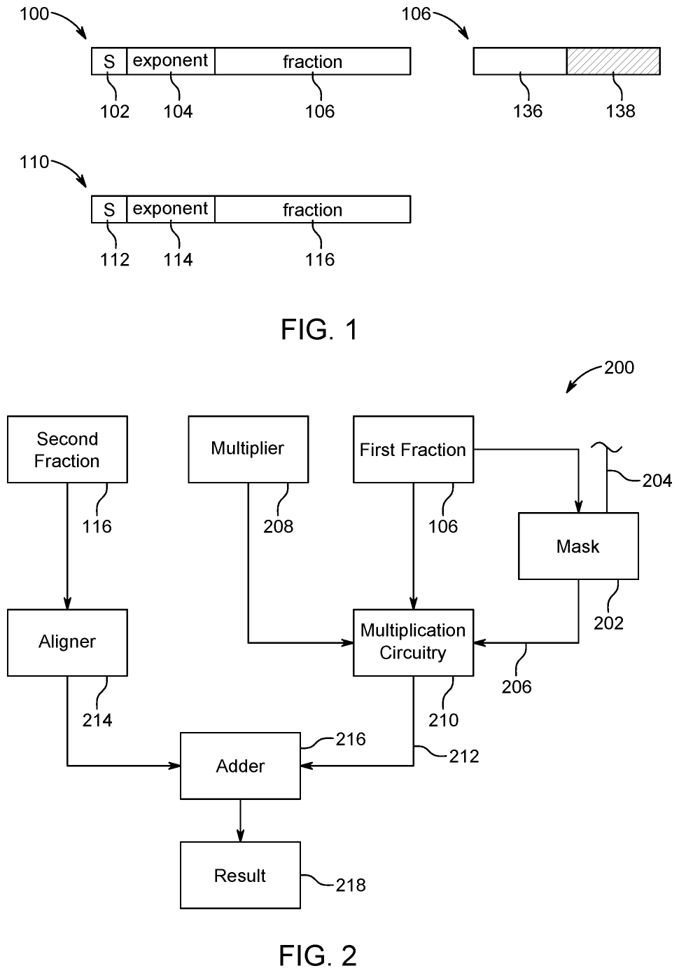

Referring to FIG. 1, a first floating-point number 100 and a second floating-point number 110 are shown. Floating-point numbers may be defined by bits or bit portions that represent sign, exponent, and fraction components. The first floating-point number 100 includes a first sign 102, designating the positive or negative attributes of the first floating-point number 100. The first floating-point number 100 includes a first exponent 104, defining the floating-point position of the first floating-point number 100. The first floating-point number 100 includes a first fraction 106, also called a mantissa, coefficient, argument or significand.

The second floating-point number 110 includes a second sign 112, designating the positive or negative attributes of the second floating-point number 110. The second floating-point number 110 includes a second exponent 114, defining the floating-point position of the second floating-point number 110. The second floating-point number 110 includes a second fraction 116, also called a mantissa, coefficient, argument, or significand.

The first fraction 106 and the second fraction 116 may be masked according to differences associated with the first exponent 104 and the second exponent 114. As one example, masking of the first fraction 106 may define a masked first fraction 136 and removed bits 138.

Those versed in the art will readily appreciate that floating numbers may be stored in registers, memory, or latches; designated as operands; and portioned for circuitry to performed operations.

Referring to FIG. 2, portions of a floating-point unit 200 are shown in accordance with one or more embodiments of the present invention. The floating-point unit 200 includes first, second, and third operands. For example, the second fraction 116 may be an operand of the floating-point unit 200. The first fraction 106 may be an operand of the floating-point unit 200. The floating-point unit 200 may also include a multiplier 208 as an operand. The floating-point unit 200 includes operand mask circuitry 202. The operand mask circuitry 202 may receive any of the operands associated with the floating-point unit 200. The operand mask circuitry 202 may receive the first fraction 106. The operand mask circuitry 202 may receive a mask command 204, designating the number and direction of bits to mask from the first fraction 106. The mask command 204 may be based on a difference between the first exponent 104 and the second exponent 114. The operand mask circuitry 202 may output a masked first fraction 136 after removed bits 138 have been removed according to the mask command 204.

The operand mask circuitry 202 outputs the masked first fraction 136 along a mask adder input 206 path to the multiplication circuitry 210. The multiplication circuitry 210 is configured to receive the mask adder input 206 and the multiplier 208. The multiplication circuitry 210 is configured to output a multiplication result 212. The multiplication result 212 is provided to fraction portion addition circuitry 216.

The fraction portion addition circuitry 216 is also configured to receive the second fraction 116. The second fraction 116 may be aligned according to alignment circuitry 214. The alignment circuitry 214 may align the second fraction 116 according to its second exponent 114. The fraction portion addition circuitry 216 may combine the second fraction 116 with the masked first fraction 136 provided by the multiplication circuitry 210. The fraction portion addition circuitry 216 may add the second fraction 116 with the masked first fraction 136. The fraction portion addition circuitry 216 outputs the result 218.

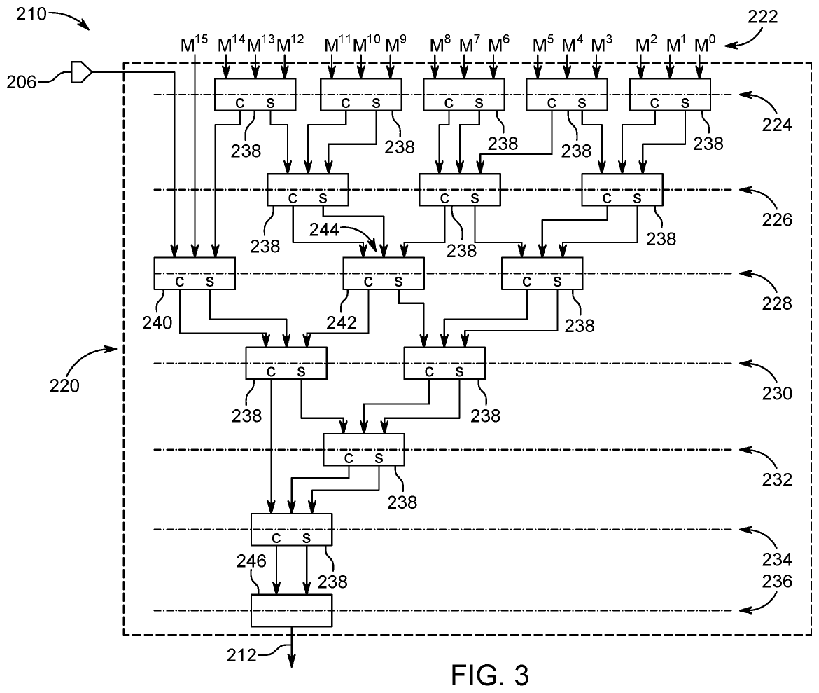

Turning now to FIG. 3, multiplication circuitry is generally shown in accordance with one or more embodiments of the present invention. As shown in FIG. 3, the multiplication circuitry 210 may include a partial product tree 220. The partial product tree 220 may include partial products 222 as input. The partial product tree 220 may include any number of partial product stages 224, 226, 228, 230, 232, 234, 236. The partial product stages 224, 226, 228, 230, 232, 234, 236 may be cascaded such that 3:2 combinations of inputs and outputs are provided. A 3:2 adder takes three inputs and generates two outputs. A one-bit 3:2 adder may be a full adder. An n-bit 3:2 adder may be n adders arranged in parallel. Any number of 3:2 adders may be stacked to add up any number of input operands. As an example, to add six operands the first three and last three operands may be added. In another stage the sums and carries of the preceding stage are added. In another stage those resulting sums and carries are added. This process is repeated until only two partial products are left. It should be appreciated that any type of partial product tree 220 may be used, including different adder ratios or encoded portions (e.g., Booth.) The partial product stages 224, 226, 228, 230, 232, 234, 236 may be cascaded as shown.

As one possible example, the partial product stages 224, 226, 228, 230, 232, 234, 236 may define a first partial product stage 228. The first partial product stage 228 may be cascaded with adder circuitry 238 associated with the multiplication circuitry 210. The adder circuitry 238 may be carry-save adders. The partial product tree 220 may further include multiplier adder circuitry 242. It should be appreciated that the multiplier adder circuitry 242 may be associated with any one of the partial product stages 224, 226, 228, 230, 232, 234, 236. Any one of the partial product stages 224, 226, 228, 230, 232, 234, 236 may be designated as a first partial product stage. The multiplier adder circuitry 242 includes multiplier adder input 244 from stage 226, which is designated as a second partial product stage. As an example, multiplier adder circuitry 242 is designated in FIG. 3 and multiplier adder circuitry 242 may be designated or replace any of the adder circuitry 238. It should be appreciated that the second partial product stage 226 may be any of the partial product stages 224, 226, 228, 230, 232, 234, 236.

The partial product tree 220 shown in FIG. 3 further includes mask adder circuitry 240. The mask adder circuitry 240 may be associated with any one of the partial product stages 224, 226, 228, 230, 232, 234, 236. The mask adder circuitry 240 may be associated stage 228 designated as a second partial stage that is cascaded from the first partial product stage. In a Booth encoded partial product tree 220, the mask adder circuitry 240 may be inserted into the partial product tree 220 at a sixth stage (e.g., any number of bit offsets inserted to adjust error in the encoding.) The sixth stage may be a correction term stage associated with correcting a negative term. A correction term stage may be any stage associated with correcting encoding errors. A partial product tree 220 may include any number of correction stages. The mask adder circuitry 240 may be inserted in a sixth correction term stage. That is, the correction term stage is the sixth incremental stage from the beginning top stage. The multiplication circuitry 210 may be a 56-bit by 56-bit multiplier. That is, the multiplication circuitry 210 may receive two 56-bit numbers.

The term “cascaded” as used herein means that the second partial product stage 226 is downstream from the first partial product stage. Some or all the adder circuitry 238 of the second partial product stage may receive input from the first partial product stage 228. The mask adder circuitry 240 includes the mask adder input 206 from the operand mask circuitry 202. The partial product tree 220 includes carry propagate adder 246. The carry propagate adder 246 outputs the multiplication result 212. It should be appreciated that if the partial products 222 are set to zero, then the multiplication result 212 will be the mask adder input 206, as propagated through the partial product tree. As such, if multiplier 208 is set to zero, partial product inputs 222 may be zero or have a numerical value of zero.

Those versed in the art will readily appreciate that any type of partial product tree 220 and carry-save adders 238 may be used. Any number of partial product stages 224, 226, 228, 230, 232, 234, 236 may be used in any order. Any one of the partial product stages 224, 226, 228, 230, 232, 234, 236 may be designated as a first partial product stage or a second partial product stage.

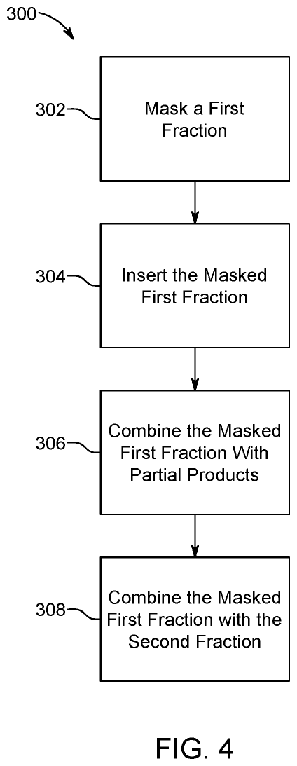

Turning now to FIG. 4, a method 300 of using multiplication circuitry for operand summation is generally shown in accordance with one or more embodiments of the present invention. The method 300 includes masking a first fraction 106 at block 302. The masking may be performed by the operand mask circuitry 202 of FIG. 2. The masking may be performed according to a difference between the first exponent 104 and the second exponent 114. The masking may be based on a comparison between the first exponent 104 and the second exponent 114. In block 304, the masked first fraction 136 may be inserted into mask adder circuitry 240 of a partial product tree 220. The insertion may include conveying the unmasked bits from the operand mask circuitry 202 to the mask adder circuitry 240.

In block 306, the masked first fraction 136 may be combined with other partial products 222 of the partial product tree 220. The combination results in the multiplication result 212. The combination may be a summation of the masked first fraction 136 with the partial products 222. It should be appreciated that the partial products 222 may be combined in any way or manner. The partial products 222 may have a value of zero. A value of zero may include having a binary value of zero, which may correspond to a predetermined voltage or logic value. In block 308, the multiplication result 212 is combined with the second fraction 116. It should be appreciated that any combination of partial products 222, multiplication results 212, first fractions 106, masked first fractions 136, or second fractions 116 may be a summation, multiplication, subtraction, or division. The partial products 222 may be set to zero by multiplying the first fraction 106 by the multiplier 208, which has a value of zero. Setting the partial products 222 to zero may include multiplying the first fraction 106 by zero by a multiplier 208 having a zero value. Zero may be a numerical value, an equivalent numerical value, a voltage value associated with the numerical value, or some other indication of a non-quantity. The comparison is a difference between the first exponent 104 and the second exponent 114.

Embodiments described herein provide operations of a floating-point unit. Those versed in the art will readily appreciate that any arithmetic unit, floating-point or otherwise, may implement teachings described herein or portions thereof. Circuitry refers to any combination of logic, wires, fundamental components, transistors, diodes, latches, switches, flip-flops, half-adders, full-adders, carry-save adders, or other implements, that may be arranged to carry the intended output or disclosed operations.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

In an exemplary embodiment, the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The instructions disclosed herein, which may execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A floating-point unit comprising:
operand mask circuitry configured to mask a first fraction by generating a masked first fraction according to a difference between a first exponent associated with the first fraction and a second exponent associated with a second fraction; and
multiplication circuitry including a partial product tree configured to output a multiplication result and having a first partial product stage cascaded with a second partial product stage, the second partial product stage including:
multiplier adder circuitry having a multiplier adder input connected to the first partial product stage; and
mask adder circuitry having a mask adder input connected to the operand mask circuitry configured to receive the masked first fraction.

2. The floating-point unit of claim 1, further comprising fraction portion addition circuitry configured to add the multiplication result and the second fraction.

3. The floating-point unit of claim 1, further comprising alignment circuitry configured to align the second fraction.

4. The floating-point unit of claim 1, wherein the second partial product stage is a correction term stage.

5. The floating-point unit of claim 4, wherein the correction term stage is a sixth stage of a 56-bit by 56-bit multiplier.

6. The floating-point unit of claim 1, wherein the multiplication circuitry further includes at least one additional partial product stage cascaded with the first partial product stage and the second partial product stage.

7. The floating-point unit of claim 1, wherein the multiplication circuitry includes a multiplier having a numerical value of zero.

8. The floating-point unit of claim 1, wherein the multiplication result is a summation of the first fraction and the second fraction.

9. A floating-point unit comprising:
multiplication circuitry including a partial product tree configured to output a multiplication result and having a first partial product stage cascaded with a second partial product stage, the second partial product stage including:
multiplier adder circuitry having a multiplier adder input connected to the first partial product stage; and
mask adder circuitry having a mask adder input connected to operand mask circuitry, the operand mask circuitry configured to output a masked first fraction.

10. The floating-point unit of claim 9, further comprising fraction portion addition circuitry configured to add the multiplication result and a second fraction.

11. The floating-point unit of claim 10, further comprising alignment circuitry configured to align the second fraction.

12. The floating-point unit of claim 9, wherein the second partial product stage is a correction term stage.

13. The floating-point unit of claim 9, wherein the masked first fraction is based on a difference between a first exponent associated with a first fraction and a second exponent associated with a second fraction.

14. The floating-point unit of claim 9, wherein the multiplication result is a summation of the first fraction and the second fraction.

15. The floating-point unit of claim 9, wherein the multiplication circuitry further includes at least one additional partial product stage cascaded with the first partial product stage and the second partial product stage.

16. A method comprising:
masking a first fraction to generate a masked first fraction according to a comparison of a first exponent associated with the first fraction and a second exponent associated with a second fraction;
inserting the masked first fraction into mask adder circuitry of a partial product tree;
combining the masked first fraction with partial products of the partial product tree as a multiplication result, the partial products having a value of zero; and
combining the multiplication result and the second fraction.

17. The method of claim 16, further comprising setting the partial products to zero by multiplying the first fraction by zero by a multiplier.

18. The method of claim 16, wherein the comparison is a difference between the first exponent and the second exponent.

19. The method of claim 16, wherein combining the masked first fraction and the second fraction is a summation of the masked first fraction and the second fraction.

20. The method of claim 16, wherein combining the masked first fraction with the partial products of the partial product tree is a summation of the masked first fraction with the partial products.
